(19) United States
(12) Patent Application Publication
(10) Pub. No.: US 2013/0222112 A1
(43) Pub. Date: Aug. 29, 2013

(54) MOBILE DEVICE HOLDER WITH INDEPENDENT POWER SOURCE TO AID IN THE LOCATING OF A MOBILE DEVICE

(71) Applicant: Harry V. Lehmann, Novato, CA (US)

(72) Inventor: Harry V. Lehmann, Novato, CA (US)

(73) Assignee: Green Swan Inc., Novato, CA (US)

(21) Appl. No.: 13/594,230

(22) Filed: Aug. 24, 2012

Related U.S. Application Data
(60) Provisional application No. 61/526,935, filed on Aug. 24, 2011.
(60) Provisional application No. 61/563,144, filed on Nov. 23, 2011.

(51) Int. Cl. G08B 3/10

(52) U.S. Cl. CPC G08B 3/10
USPC 340/8.1

(57) ABSTRACT

An apparatus, system, and method for locating a mobile device. A mobile device holster or case encloses a battery, radio transponder, notification element, and associated circuitry. A remote activator transmits a radio signal which is received by said radio transponder, activating said notification element and alerting the user of the location of said mobile device.

### PRIORITY CLAIM

This application claims priority under 35 U.S.C. §119(e) from U.S. Provisional Pat. Ser. No. 61/526,935 entitled “A Transponder Integrated into a Cellular Telephone Holster or Case” filed Aug. 24, 2011, and from U.S. Provisional Pat. Ser. No. 61/563,144 entitled “An Integrated Power Supply in a Cellular Telephone Holster” filed Nov. 23, 2011, the entirety of which are hereby incorporated by reference herein.

### BACKGROUND

The present disclosure generally relates to apparatuses, systems, and methods for locating mobile devices. More particularly, the present disclosure relates to a mobile device holster or case integrated with a remote locator.

Cellular telephones and similar mobile devices are frequently misplaced or temporarily lost by their owners. Locating a mobile device can be a difficult and frustrating experience, particularly when a device has been turned off, left in vibrate mode, or misplaced a sufficiently long period of time that the battery has died. To locate the device in these situations the device's owner must rely on memory, a thorough search, or luck.

The present disclosure provides a solution to the problem of lost mobile devices by integrating a locating system into a mobile device holster or case. A battery enclosed in the holster or case ensures the locator will have an independent power supply regardless of the condition of the device itself. The notification element in the present disclosure is envisioned as a light, sound emitter, non-aural vibrator, or any combination thereof, providing the user an easy method of locating the misplaced mobile device.

There are many consumer products available today that fall into the broad category of “item locators.” However, the existing art has not been extended to aide in the location of cellular telephones and mobile devices. In typical iterations of the prior art, a short-range radio signal emitter is sold along with several receivers; the receivers are in turn affixed to items, such as keys, which the consumer anticipates misplacing. In typical iterations, existing item locators must be attached to each item using a key ring or other mechanical means.

The present disclosure has several advantages over prior art. First, because the location device is integrated into a mobile device holster or case, the present disclosure provides an easy method for connecting the mobile device and the locator device by simply placing the mobile device in the mobile device holster or case. Second, the locator device is integrated into the mobile device holster or case such that the locator device is protected by the exterior of the holster or case and there are no protrusions which would otherwise be subject to external stresses. Third, integrating the locator device into the mobile device holster or case rather than the mobile device itself allows for activating the notification element even if the mobile device is turned off or left in vibrate mode. Finally, providing a power supply independent from the mobile device allows activating the notification element regardless of the condition of the mobile device; thus, a mobile device whose battery has died may still be located.

### BRIEF DESCRIPTION OF THE DRAWINGS

The following will be apparent from elements of the figures, which are provided for illustrative purposes and are not necessarily to scale.

FIG. 1A presents a top view of an exemplary mobile device holster.

FIG. 1B presents a side view of an exemplary mobile device holster.

FIG. 1C presents a bottom view of an exemplary mobile device holster.

FIG. 2A presents a top view of an exemplary remote activator.

FIG. 2B presents a side view of an exemplary remote activator.

### DETAILED DESCRIPTION

With reference to the figures where like elements have been given like numerical designations to facilitate an understanding of the present subject matter, the various embodiments are herein described. The following detailed description is merely exemplary in nature and is not intended to limit the described embodiments or the application and uses of the described embodiments.

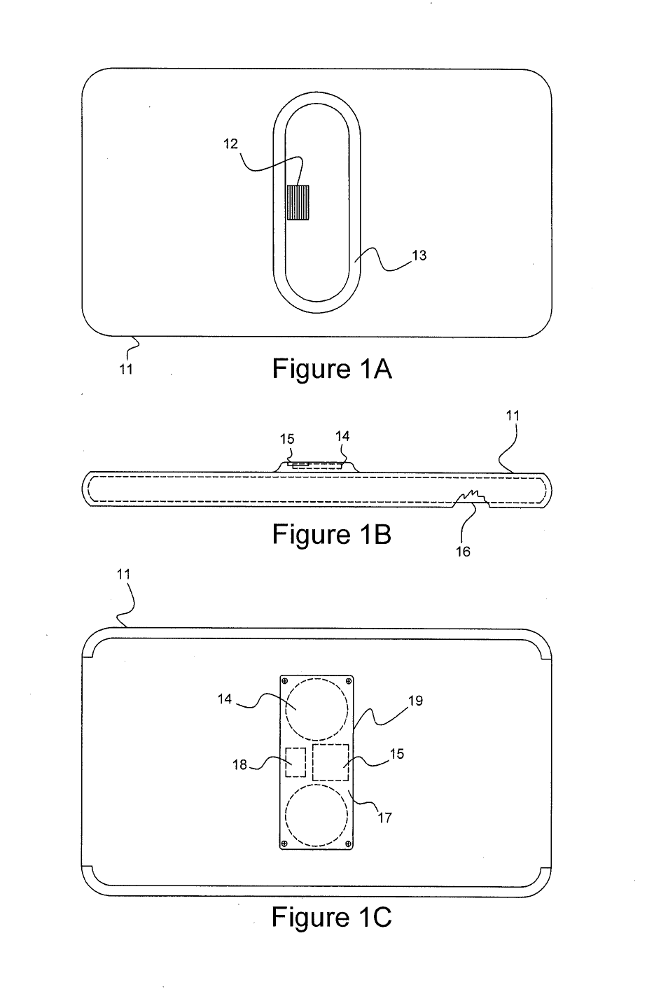

FIGS. 1A-1C show a mobile device holster 11 with integrated locator device which is one embodiment of the present disclosure and illustrates its various components. The belt clip 13 is affixed to one side of the mobile device holster 11 to securely hold the holster 11 to one's person. The holster 11 is designed to readily accept a mobile device or cellular telephone 16, protecting the mobile device or cellular telephone without interfering with its normal functionality

A battery well 17 contains at least one battery 14, the radio transponder 18, and associated circuitry 15 of the locator device. The battery well is secured by a plate 19 that covers the well and sits flush with the inside of the holster 11. This plate may be secured to the holster using screws.

In the illustrated embodiment, the notification element is a sound emitter 12. The notification element is variously envisioned as a sound emitter, a light, a non-aural vibrator, or any combination thereof.

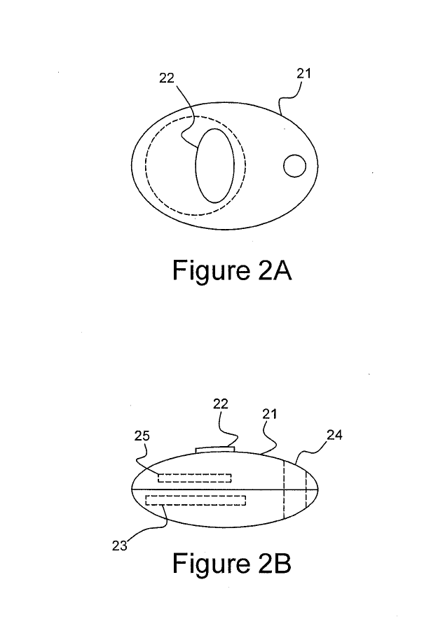

FIGS. 2A-2B show the remote activator. A radio transmitter 25 and battery 23 are enclosed in a case 21. The radio transmitter 25 is prompted to transmit a signal by depressing a button 22. The case 21 is fitted with an aperture 24 such that it may be easily affixed to other objects, preferably a key chain ring.

In use, a person searching for their mobile device depresses the remote activator button 22. The radio transmitter 25 located in the remote activator sends a radio signal to the radio transponder 18 located in the mobile device holster 11. The radio transponder 18 then notifies, via associated circuitry 15, the sound emitter 12 to notify the user of the mobile device holster's location.

In another embodiment, the mobile device holster is a mobile device case, lacking a means of affixing the case to one's person. In this embodiment, the radio transponder, battery, associated circuitry, and notification elements remain positioned in said case, such that there are no protrusions from the case.

Although examples are illustrated and described herein, embodiments are nevertheless not limited to the details shown, since various modifications and structural changes may be made therein by those of ordinary skill within the scope and range of equivalents of the claims.

We claim:

1. A system for locating a mobile device, comprising:
a mobile device holster, for enclosing and protecting a mobile device without interfering with the normal functionality of said device, wherein a belt clip or belt loop is coupled to the holster to securely hold a mobile device to one's person;
a battery well, positioned in said holster, configured to receive a battery;
a plate, secured by screws to said holster, to cover the battery well;
a radio transponder, positioned in said holster;
a notification element, positioned in said holster;
associated circuitry, positioned in said holster, which will process a signal from the radio transponder and activate the notification element;
a battery or batteries to provide electrical power to the radio transponder, notification element, and associated circuitry; and,
a remote activator, separate from said holster, which includes an aperture for attachment to a key ring and a button, wherein depressing said button will send a radio signal to said radio transponder, which will be processed by said associated circuitry, which will activate said notification element.

2. A system for locating a mobile device, as recited in claim 1, wherein the notification element is a sound emitter.

3. A system for locating a mobile device, as recited in claim 1, wherein the notification element is a light.

4. A system for locating a mobile device, as recited in claim 1, wherein the notification element is a non-aural vibrator.

5. A system for locating a mobile device, as recited in claim 1, wherein the notification element comprises a sound emitter, a light, and a non-aural vibrator.

6. A system for locating a mobile device, as recited in claim 1, wherein said battery well, plate, radio transponder, notification element, associated circuitry, and batteries are positioned flush with the exterior of the mobile device holster, such that no protrusions are evident.

7. A method comprising:
receiving an input from a user to query the location of a mobile device;
sending a radio signal based on said input to a radio transponder positioned in a mobile device holster or case;
activating a notification element based on the processing of said radio signal by associated circuitry, wherein the notification element and associated circuitry is powered by an independent power source positioned in the mobile device or case.

8. A method for locating a mobile device, as recited in claim 7, wherein activating said notification element creates a sound for notifying an individual of the location of the mobile device holster or case.

9. A method for locating a mobile device, as recited in claim 7, wherein activating said notification element illuminates a light for notifying an individual of the location of the mobile device holster or case.

10. A method for locating a mobile device, as recited in claim 7, wherein activating said notification element creates a non-aural vibration for notifying an individual of the location of the mobile device holster or case.

11. A method for locating a mobile device, as recited in claim 7, wherein activating said notification element creates a sound, illuminates a light, and creates a non-aural vibration for notifying an individual of the location of the mobile device holster or case.

12. An apparatus for locating a mobile device, comprising:
a mobile device holster or case, for enclosing and protecting a mobile device without interfering with the normal functionality of said device;
a battery well, positioned in said holster or said case, configured to receive a battery;
a radio transponder, positioned in said holster or said case;
a notification element, positioned in said holster or said case; and,
associated circuitry, positioned in said holster or said case, which will process a signal from the radio transponder and activate the notification element.

13. An apparatus for locating a mobile device, as recited in claim 12, wherein the notification element is a sound emitter.

14. An apparatus for locating a mobile device, as recited in claim 12, wherein the notification element is a light.

15. An apparatus for locating a mobile device, as recited in claim 12, wherein the notification element is a non-aural vibrator.

16. An apparatus for locating a mobile device, as recited in claim 12, wherein the notification element comprises a sound emitter, a light, and a non-aural vibrator.

17. A apparatus for locating a mobile device, as recited in claim 12, wherein said battery well, plate, radio transponder, notification element, associated circuitry, and batteries are positioned flush with the exterior of the mobile device holster, such that no protrusions are evident.

18. An apparatus for locating a mobile device, as recited in claim 12, further comprising a belt clip or belt loop is coupled to the holster to securely hold a mobile device to one's person.

19. An apparatus for locating a mobile device, as recited in claim 12, further comprising a flashlight positioned in said holster or said case.

20. An apparatus for locating a mobile device, as cited in claim 12, comprising a battery positioned in said battery wall, said radio transponder, notification element and associated circuitry is powered by said battery.
